(19) United States
(12) Patent Application Publication
(10) Pub. No.: US 2018/0201216 A1
(43) Pub. Date: Jul. 19, 2018

(54) METHOD AND DEVICE FOR CONTROLLING A PERSONAL PROTECTION DEVICE FOR A VEHICLE

(71) Applicant: Robert Bosch GmbH, Stuttgart (DE)

(72) Inventors: Heiko Freienstein, Weil Der Stadt (DE); Josef Kolatschek, Weil Der Stadt (DE)

(21) Appl. No.: 15/736,387

(22) PCT Filed: Apr. 6, 2016
(86) PCT No.: PCT/EP2016/057499

§ 371 Date: Dec. 14, 2017

(30) Foreign Application Priority Data
Jun. 30, 2015 (DE) 10 2015 212 144.5

(51) Int. Cl. B60R 21/015; B60R 21/013

(52) U.S. Cl. CPC B60R 21/01512; B60R 2021/01286; B60R 21/013

(57) ABSTRACT

A method for controlling a personal protection device for a vehicle. The method includes a step of determining a set of control variants for controlling the personal protection device, from a plurality of possible control variants for controlling the personal protection device, using an inaccurate situational value and at least one inaccuracy value, the inaccurate situational value representing a value ascertained using a sensor of the vehicle, and the inaccuracy value defining an inaccuracy of the inaccurate situational value; and a step of selecting a control variant assigned to the inaccurate situational value, from the plurality of possible control variants, as a control variant selected for controlling the personal protection device, if each control variant of the set of control variants is assigned a safety class, which satisfies a safety criterion necessary for controlling the personal protection device.

### FIELD

The present invention relates to a device and a method for controlling a personal protection device for a vehicle. The present invention also relates to a corresponding computer program.

### BACKGROUND INFORMATION

In the passive safety of motor vehicles, occupant protection devices, such as an airbag and a seat belt, are controlled on the basis of acquired, measured variables.

### SUMMARY

In accordance with the present invention, a method for controlling a personal protection device for a vehicle is provided, in addition, a device that applies this method, and finally, a corresponding computer program. Advantageous refinements and improvements of the device are described herein.

Measured variables, which may be used for controlling personal protection devices, typically have inaccuracy. This inaccuracy may be taken into account in the control of a personal protection device. In this manner, personal protection may be improved.

A method for controlling a personal protection device for a vehicle includes the following steps:

determining a set of control variants for controlling the personal protection device, from a plurality of possible control variants for controlling the personal protection device, using an inaccurate situational value and at least one inaccuracy value; the inaccurate situational value representing a value ascertained, using a sensor of the vehicle, and the inaccuracy value defining an inaccuracy of the inaccurate situational value; and
selecting a control variant assigned to the inaccurate situational value, from the plurality of possible control variants, as a control variant selected for controlling the personal protection device, if each control variant of the set of control variants is assigned a safety class, which satisfies a safety criterion necessary for controlling the personal protection device.

A personal protection device may be understood as a device for protecting an occupant of a vehicle or a person situated in the area of the vehicle. The personal protection device may be, for example, an airbag or a seat belt. The personal protection device may be controlled, for example, during or in the run-up to a collision of the vehicle with an obstacle. The personal protection device may be controlled in varied ways. The different manners of control may be determined by the plurality of possible control variants. A control variant may define a time characteristic of an activation of personal protection device or a restraining force supplied by the personal protection device, or it may determine which component of a plurality of components of the personal protection device is controlled. A situational value may constitute a value supplied by a sensor or a value ascertained from a value supplied by a sensor.

An example of such a sensor is a surround sensor, passenger-compartment sensor or another vehicle sensor normally used for controlling a personal protection device. Thus, the situational value may also be a measured value. The situational value may indicate a current situation of the vehicle, for example, an acceleration or deformation or a current situation of a person, for example, a relative movement of the person and the vehicle. The inaccuracy of the inaccurate situational value may be produced, for example, by measurement inaccuracy of a sensor, or inaccuracies occurring during further processing of a sensor value. Each possible situational value may be assigned a control variant. Due to the inaccuracy of the inaccurate situational value, there is the possibility that the inaccurate situational value does not indicate the actual, current situation, but a situation deviating from it. A limiting value or a deviation for the inaccurate situational value may be defined by an inaccuracy value. For controlling the personal protection device, in order to prevent that, on the basis of the inaccuracy, a control variant is selected that is not suitable for the current situation, safety classes of the control variants, which could be used for controlling the personal protection device due to the inaccuracy of the situational value, may be checked. In this manner, it may advantageously be ensured that a control variant assigned to the inaccurate situational value is only selected, if the control variants able to be used for controlling the personal protection device due to the inaccuracy of the situational value have a necessary safety class. A necessary safety class may be attained, when no risk to the person to be protected by the personal protection device is to be expected from the use of a control variant.

According to one specific embodiment, in the determining step, an interval of possible situational values justified by the inaccuracy may be determined, using the inaccurate situational value and the at least one inaccuracy value. An error interval surrounding the inaccurate situational value may constitute such an interval. For example, the interval may be delimited by two inaccuracy values. The inaccurate situational value may be situated inside of the interval. In this manner, the control variants assigned to the possible situational values may be determined as the set of control variants, from the plurality of possible control variants.

The method may include a step of selecting one control variant as a control variant classified as safe, from the plurality of possible control variants, as the control variant selected for controlling the personal protection device, if at least one control variant of the set of control variants is assigned a safety class, which does not satisfy the safety criterion necessary for controlling the personal protection device. In this case, the control variant classified as safe may be selected for controlling the personal protection device, in place of the control variant assigned to the inaccurate situational value. A control variant classified as safe may be understood to be a control variant, which prevents risk to the person to be protected by the personal protection device.

The method may include a step of determining at least one adjusted inaccuracy value, using the at least one inaccuracy value and an adaptation rule. Such a procedure may then be useful, if at least one control variant of the set of control variants is assigned a safety class, which does not satisfy the criterion necessary for controlling the personal protection device. For example, an error interval surrounding the inaccurate situational value may be shortened by the adaptation rule. This may allow the set of control variants to be reduced in size. Consequently, in a determining step, an adjusted set of control variants may be determined, using the inaccurate situational value and the at least one adjusted inaccuracy value. In a selecting step, this allows the control variant assigned to the inaccurate situational value to be selected, if each control variant of the adjusted set of control variants is assigned a safety class, which satisfies the safety criterion necessary for controlling the personal protection device. In this manner, it may be checked if the use of the control variant assigned to the inaccurate situational value is even possible after all. If the use of this control variant is still not possible, then the control variant classified as safe may be selected.

The method may include a checking step, in which it is checked if each control variant of the set of control variants is assigned a safety class, which satisfies the safety criterion necessary for controlling the personal protection device. According to one specific embodiment, the checking step may be implemented, using a lookup table, for example, a risk matrix. Alternatively, the checking step may be carried out while implementing a combining rule.

The method may include a step of adjusting a safety class of at least one control variant, using a person-specific situational value. For example, the safety class of one or more, for example, even all, control variants of the set of control variants or all control variants of the plurality of possible control variants may be adjusted. In the adjusting step, a safety class may be assigned for the first time or reassigned, or an existing safety class may be changed. The person-specific situational value may represent a value ascertained, using a sensor of the vehicle. For example, the person-specific situational value may indicate a bodily position of a person to be protected by the personal protection device, or a movement of the person. In this manner, control of the personal protection device may be adjusted to a state of the person to be protected.

According to one specific embodiment, in the determining step, the set of control variants may be determined, using at least one further, inaccurate situational value and at least one further inaccuracy value. In this context, the at least one further, inaccurate situational value may represent a value ascertained, using a sensor of the vehicle, and the at least one further inaccuracy value may define an inaccuracy of the at least one further, inaccurate situational value. Correspondingly, in the selecting step, a control variant assigned to the inaccurate situational value and the at least one further, inaccurate situational value may be selected from the plurality of possible control variants as the control variant selected for controlling the personal protection device, if each control variant of the set of control variants is assigned a safety class, which satisfies a safety criterion necessary for controlling the personal protection device. In this manner, a plurality of situational values may be taken into account in the selection of the control variant.

The method may be implemented, for example, as software or hardware, or in a combined form of software and hardware, in, for example, a control unit.

The approach put forward here further provides a device, which is configured to perform, control and/or implement the steps of a variant of a method put forward here, in corresponding devices. The object of the present invention may also be achieved quickly and efficiently by this embodiment variant of the present invention, in the form of a device.

In the case at hand, a device may be understood as an electrical device that processes sensor signals and outputs control and/or data signals as a function of them. The device may have an interface, which may be implemented as hardware and/or software. In a hardware design, the interfaces may, for example, be part of a so-called system ASIC that includes many different functions of the control device. However, it is also possible for the interfaces to be separate, integrated circuits or to be at least partially made up of discrete components. In a software design, the interfaces may be software modules that are present on a microcontroller in addition to other software modules, for example.

Also advantageous is a computer program product or computer program, including program code, which may be stored on a machine-readable carrier or storage medium, such as a solid state memory, a hard disk storage device or an optical storage device, and is used for performing, implementing and/or controlling the steps of the method according to one of the above-described specific embodiments, in particular, when the program product or program is executed on a computer or a device.

Exemplary embodiments of the present invention are shown in the figures and explained in greater detail below.

### BRIEF DESCRIPTION OF THE DRAWINGS

FIG. 1 shows a schematic representation of a vehicle having a device for controlling a personal protection device according to one exemplary embodiment.

FIG. 2 shows a block diagram of a device for controlling a personal protection device according to an exemplary embodiment.

FIG. 3 shows a flow chart of a method for controlling a personal protection device according to an exemplary embodiment.

FIG. 4 shows a selection of different control variants as a function of a threshold value decision, according to one exemplary embodiment.

FIG. 5 shows a risk matrix according to an exemplary embodiment.

FIG. 6 shows a risk matrix according to an exemplary embodiment.

FIG. 7 shows a risk matrix according to an exemplary embodiment, in which an error region is plotted.

FIG. 8 shows a risk matrix according to an exemplary embodiment, in which an error region is plotted.

FIG. 9 shows a risk matrix according to an exemplary embodiment, in which an error region is plotted.

FIG. 10 shows a schematic representation of the control variants for the belt force as a function of the variable, “age,” in accordance with an exemplary embodiment.

FIG. 11 shows a risk matrix according to an exemplary embodiment.

### DETAILED DESCRIPTION OF EXAMPLE EMBODIMENTS

In the following description of preferred exemplary embodiments of the present invention, the same or similar reference numerals are used for the elements that are shown in the various figures and function similarly, in which case a repeated description of these elements is omitted.

FIG. 1 shows a schematic representation of a vehicle 100 having a device 102 for controlling a personal protection device 104 according to an exemplary embodiment. Personal protection device 104, for example, an airbag, is provided in order to protect a person 106 in the case of an accident. According to this exemplary embodiment, person 106 is an occupant of vehicle 100. Alternatively, personal protection device 104 may be provided, in order to protect a further road user, for example, a pedestrian.

Vehicle 100 has a sensor 108. Sensor 108 is configured to provide an inaccurate situational value 110 to device 102. According to this exemplary embodiment, inaccurate situational value 110 is a sensor value, which is provided by sensor 108 and indicates, for example, an acceleration of vehicle 100. As an alternative, the sensor value of sensor 108 may be processed further, for example, combined with further sensor values, and subsequently supplied to device 102, in the form of a further-processed sensor value, as the inaccurate situational value 110.

According to this exemplary embodiment, sensor 108 is configured to supply, together with inaccurate situational value 110, an inaccuracy value 112 to device 102, the inaccuracy value defining an inaccuracy of the inaccurate situational value. Alternatively, device 102 may be configured to receive or fetch out inaccuracy value 112 from a further device.

Device 102 is configured to select a control variant 116 for controlling personal protection device 104, from a plurality of control variants available for controlling personal protection device 104, using inaccurate situational value 110 and inaccuracy value 112, and to supply selected control variant 116 or a control signal 116 based upon selected control variant 116, to personal protection device 104, in order to control personal protection device 104.

According to an exemplary embodiment, vehicle 100 has a further sensor 118, which is configured to supply a person-specific situational value 120 to device 102. According to this exemplary embodiment, person-specific situational value 120 is a sensor value, which is provided by sensor 118 and indicates, for example, an acceleration of person 106, or indicates, for example, an age or a build of person 106 on the basis of an image analysis.

According to an exemplary embodiment, vehicle 100 has a further sensor 122, which is configured equivalently to sensor 108, to supply a further, inaccurate situational value 124 and a further inaccuracy value 126 to device 102. In this case, device 102 is configured to select control variant 116 for controlling personal protection device 104, using, in addition, further, inaccurate situational value 124 and further inaccuracy value 126.

In the passive safety of motor vehicles 100, occupant protection devices 104, such as an airbag and a seat belt, are controlled on the basis of acquired, measured variables 110, 120, 124. An example of such measured variables 110, 120, 124 is the vehicle acceleration. Using an activation algorithm, the acceleration signal is analyzed and a triggering or activation decision for available restraining devices 104 is acquired in a particular manner. In this context, the triggering or activation decision is made on the basis of predefined criteria, such as accident type and accident severity.

A core of such triggering algorithms may be the calculation of a threshold value, which is a function of one or more characteristics derived from an acceleration signal, as well as the comparison of it to another characteristic, e.g., the speed obtained by integrating the acceleration values.

Using the described approach, the potential inaccuracy of the data 110, 120, 124 used, as is produced, e.g., by the use of inexpensive sensors 108, 118, 122; of the possible fluctuations of the characteristics of the measured signals due to manufacturing variations or ageing-related changes in the transmission path in vehicle 100; and of other possible statistical effects, may be considered directly in the decision-making. In particular, it is taken into account that the potential inaccuracy may take on different variables over the range of application, and that on the other hand, the effects of these inaccuracies on the occupants may vary, depending on if the inaccuracy then assumes a large value precisely when the situation is such that, on the basis of measured value 110, 120, 124, a decision must be made between two alternative options of controlling restraining devices 104.

An example of such a situation is when, due to a known characteristic of vehicle 100 such as a resonance at the mounting location, measured value 110, 120, 124 of the acceleration then exhibits a larger degree of inaccuracy precisely when the decision between a 1-stage or a 2-stage activation of air bag 104 must be made. Another example relates to the adaptive control of restraining devices 104 as a function of occupant characteristics. It may be useful, e.g., to differentiate between infants, youths, young adults, middle-aged adults, and seniors. In this context, in particular, in the case of seniors, as well as infants and youths, it is desirable to control restraining devices 104 markedly differently than in the case of young adults and middle-aged adults. The differentiation, as to which age group a person 106 is assigned, is typically based on faulty data. The reason for this is, for example, the uncertainty in measurement of the sensor technology used. If, on the basis of this faulty data, a senior were to be mistakenly classified as a young adult, this could cause an increased risk of injury to the occupant due to, for example, restraining forces of the seat belt system that are set higher. In order to prevent such errors, highly strict standards regarding the quality of the data must be set in the case of present systems. For example, it may be stipulated that the age approximation must be carried out in such a manner, that the deviation from the true age is not greater than two years. However, such accuracy may only be achieved in the rarest of cases. The result of this is that systems, which consider the age of the occupant for the control, are still not widely used.

This problem is solved in accordance with an exemplary embodiment of the approach set forth here, using a method and a device for controlling passive-safety components 104 with the aid of adjusted decision thresholds.

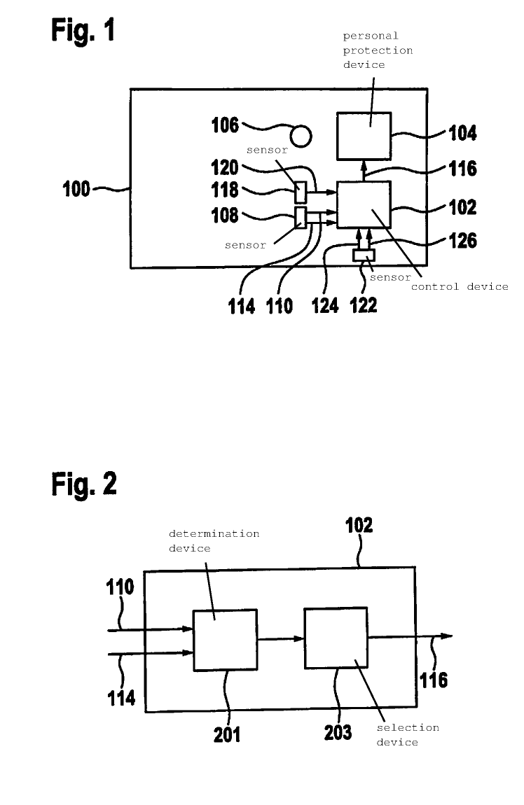

FIG. 2 shows a block diagram of a device 102 for controlling a personal protection device according to an exemplary embodiment. In this context, the device may be the device described in light of FIG. 1.

Device 102 is configured to read in an inaccurate situational value 110 and at least one inaccuracy value 114 via an interface, using inaccurate situational value 110 and the at least one inaccuracy value 114, in order to select a control variant 116 for controlling the personal protection device, and to supply selected control variant 116 via an interface.

Device 102 has a determination device 201 and a selection device 203. Determination device 201 is configured to determine, using inaccurate situational value 110 and the at least one inaccuracy value 114, a set of control variants from a plurality of possible control variants for controlling the personal protection device. If the control variants encompassed by the set of control variants have a safety class, which satisfies a necessary safety criterion, then selection device 203 is configured to select a control variant assigned to the inaccurate situational value, from the plurality of possible control variants, as the control variant 116 selected for controlling the personal protection device. The plurality of possible control variants may be stored, for example, in a storage device of device 102. In the same way, an association between possible situational values and possible control variants may be stored in a storage device of device 102.

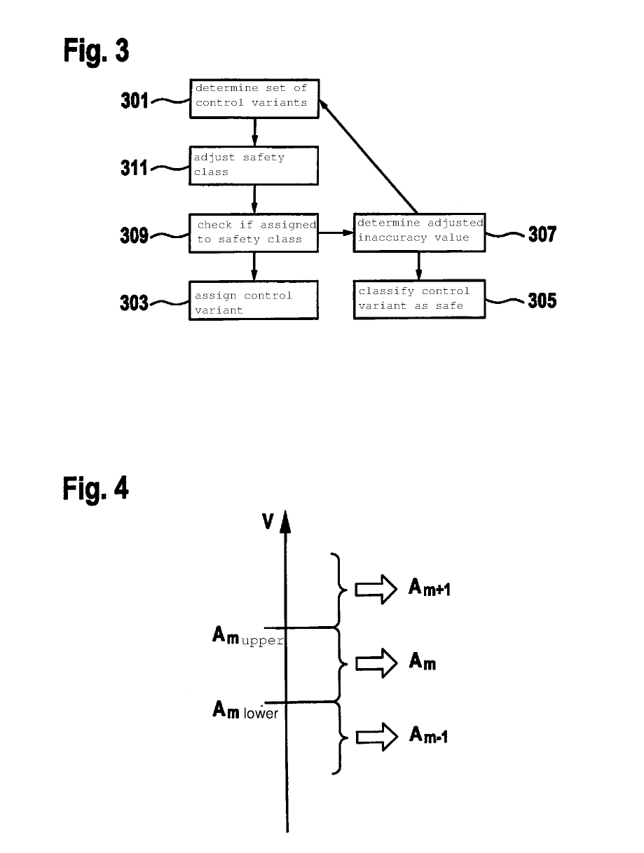

FIG. 3 shows a flow chart of a method for controlling a personal protection device according to an exemplary embodiment. The steps of the method may be implemented by a device, as is described in light of the figures described above.

The method includes a step 301 of determining a set of control variants for controlling the personal protection device, from a plurality of possible control variants for controlling the personal protection device, using an inaccurate situational value and at least one inaccuracy value; as well as a selecting step 303, in which a control variant assigned to the inaccurate situational value is selected from the plurality of possible control variants, if the control variants of the set of control variants have a necessary safety class.

According to one exemplary embodiment, in step 301, two or more inaccurate situational values and corresponding inaccuracy values may be used in order to determine the set of control variants.

If the control variants of the set of control variants do not have the necessary safety class, then, according to an exemplary embodiment, a step 305 is performed, in which a control variant classified as safe is selected as the control variant selected for controlling the personal protection device. The control variant classified as safe may be fixed, or, for example, selected as a function of the inaccurate situational value.

As an option, the method includes a step 307 of determining at least one adjusted inaccuracy value, using the at least one inaccuracy value and an adaptation rule. Step 307 may be performed, if at least one control variant of the set of control variants is assigned a safety class, which does not satisfy the safety criterion necessary for controlling the personal protection device. In this case, an adjusted set of control variants is determined, using the inaccurate situational value and the at least one adjusted inaccuracy value, for example, by performing step 301 again with modified input parameters. Subsequently, either step 303 is performed, if each control variant of the adjusted set of control variants is assigned a safety class, which satisfies the safety criterion necessary for controlling the personal protection device; or step 305 is performed, if at least one control variant is assigned a safety class, which does not satisfy the safety criterion necessary for controlling the personal protection device. In place of performing step 301 again, an additional step corresponding to step 301 may also be carried out.

To decide whether step 303 or step 305 is performed, an additional step 309 is optionally carried out, in which it is checked if every control variant of the set of control variants is assigned a safety class, which satisfies the safety criterion necessary for controlling the personal protection device. For example, the safety criterion of a control variant may be considered satisfied, if the control variant is assigned a first value, for example, “0,” and considered unsatisfied, if the control variant is assigned a second value, for example, “1.”

According to one exemplary embodiment, the method includes an optional step 311, in which the safety class of at least one control variant is adjusted, using a person-specific situational value. The person-specific situational value may be based, for example, upon a value acquired by the sensor 118 shown in FIG. 1.

The method according to one embodiment of the present invention, in which in the step of determining a set of control variants, the set of control variants is determined, using at least one further, inaccurate situational value and at least one further inaccuracy value; the at least one further, inaccurate situational value representing a value ascertained using a sensor of the vehicle, and the at least one further inaccuracy value defining an inaccuracy of the at least one further, inaccurate situational value; and in the selecting step, a control variant assigned to the inaccurate situational value and to the at least one further, inaccurate situational value being selected from the plurality of possible control variants as the control variant selected for controlling the personal protection device, if each control variant of the set of control variants is assigned a safety class, which satisfies a safety criterion necessary for controlling the personal protection device.

Exemplary embodiments of the present invention are described in detail in light of the following figures, where the potentially varying inaccuracy of the input data and the different, possible control variants, also referred to below as control instances, of the restraint system, are combined via a computational method in such a manner, that the risk to the occupants by wrong decisions is minimized.

In particular, in cases in which a selection between alternative control instances must be made and incorrect control would mean a marked risk to the occupant, a criterion for utilizing the input data is used, which is expressed in such a manner, that such a control instance takes place, if the input data satisfies particular quantitative criteria, which are comparatively narrow. If this criterion is not satisfied, then a switch is made to a control instance, of which it is known that it results in no risk or only a tolerably small risk to the occupants.

On the other hand, in the case of such alternative control instances, in which incorrect control would mean no risk or only a tolerably small risk to the occupants, a criterion is used, which is formed quantitatively in such a manner, that a selection from the alternative control instances is always made. Therefore, in this case, the criterion is expressed comparatively broadly.

FIG. 4 shows a selection of different control variants Aₘ₊₁, Aₘ, Aₘ₋₁ as a function of a threshold value decision, according to an exemplary embodiment. If a variable V is greater than a threshold S_A_{m upper}, then control variant Aₘ₊₁ is selected. If variable V is greater than a threshold S_A_{m lower} and less than threshold S_A_{m upper}, control variant Aₘ is selected. If variable V is less than threshold S_A_{m lower}, control variant Aₘ₋₁ is selected. Therefore, there is a functional relationship of control variants Aₘ₊₁, Aₘ, Aₘ₋₁ to the value of variable V.

A number n of different control variants Aₘ (0<m≤n) of a component of a restraint system is based on a quantitative variable V in such a manner, that when V is greater than a lower limit Aₘ_{_}_{lower} and less than an upper limit Aₘ_{_}ᵤₚₚₑᵣ, the component of the restraint system is controlled using control variant Aₘ, as is shown in FIG. 4. Thus:

If (Aₘ_{_}_{lower}<V<Aₘ_{_}ᵤₚₚₑᵣ), then (control variant=Aₘ).

That is, a mapping a: V->Aₘ is carried out. Mapping a is generally referred to as a triggering algorithm.

The incorrect value of variable V, which is actually available, is the value M. The error of M is F(M), F(M) being able to be a discontinuous, non-monotonic, and also asymmetric, arbitrary assignment of an error range F to a respective value of M. Correspondingly, mapping a maps value M to control variant Aₗ: a: M->Aₗ. However, since M is incorrect (the true, correct value is V), Aₗ does not have to correspond to actually correct control Aₘ.

A risk matrix G may be generated from control variants Aₘ and Aₗ, the risk matrix quantitatively indicating how large the potential risk is if, by mistake, variant Aₗ were to be erroneously selected on the basis of M, instead of the correct control variant Aₘ corresponding to variable V.

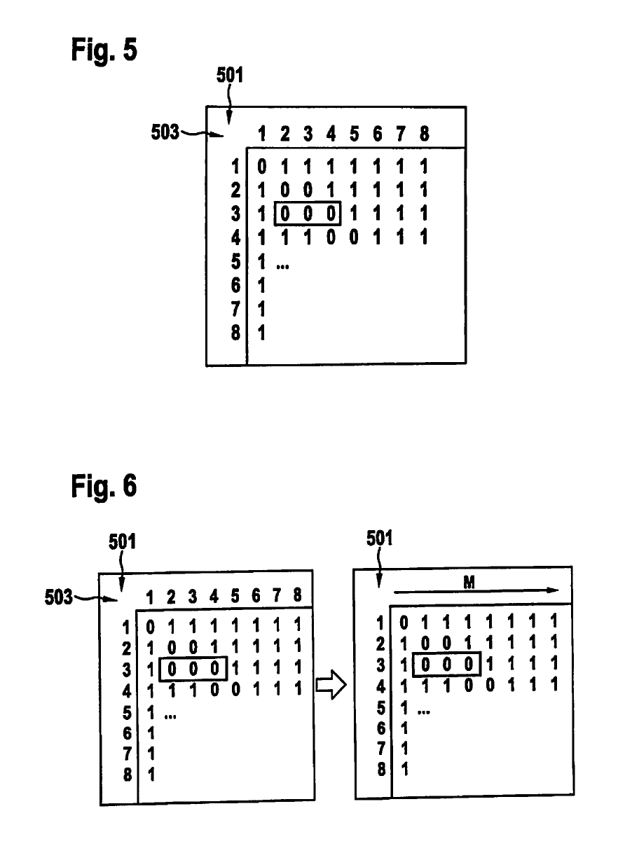

FIG. 5 shows a risk matrix G according to an exemplary embodiment. Correct control variants 501 are plotted on the ordinate, and assumed control variants 503 are plotted on the abscissa. In the following, control variants 501, 503 are also referred to as control instances. Entry “1” means that the occupant is exposed to an increased risk of injury. Entry “0” denotes no increase or only a slight increase in the risk. It is apparent from framed section 505 that there is no additional risk to the occupants, if control instance “2” or “4” is implemented instead of correct control instance “3.”

In other words, in risk matrix G, for example, the correct, necessary control instance is plotted downwards, and the control instance actually adopted is plotted to the right. The components aᵢₖ of this matrix may be simplified to the effect that if a risk is present, entry aᵢₖ is set equal to 1, otherwise, entry aᵢₖ=0; any sensible criterion for deciding between these classes being able to be used. Components aᵢₖ of matrix G may be calculated both in real time and in advance. Sources of the entries may include experiments, simulations or expert knowledge. The entries may be calculated or adjusted in real time, e.g., for a gender-specific adjustment, for example, on the basis of model computations, which are carried out in the control unit.

According to this exemplary embodiment, the values “0” are always present in the diagonals of this matrix G, since in this connection, it is the case that the measured value corresponds exactly to the required value.

Thus: (aᵢₖ=0)∀{aᵢₖ|i=k}.

If one or more “0”-entries in direct succession are also situated to the left or to the right of the diagonals (row value i=constant), these control variants are, to be sure, not optimal, but when these variants are selected, no additional risk to the occupant occurs.

Also, instead of the actual control instance plotted to the right, risk matrix G may be expressed by the measured value M corresponding to this control instance.

On this basis, the required accuracy, which the particular measured value M must have in order that no control instance disadvantageous to the occupant occurs, may now be calculated: The possible error of M permitted may not be so large that it results in a control variant, for which aᵢₖ=1. The lower value of M, which leads, in the described manner, to a control variant that is designated by “1,” shall be M_{L}; the corresponding upper value shall be Mᵤ, as is shown in FIG. 6.

FIG. 6 shows a corresponding risk matrix G according to an exemplary embodiment, in which the axis of the assumed control variants 503 is replaced by the values M corresponding to them. The correct control variants 501 are each plotted on the ordinate. Risk matrix G is also referred to as a risk table.

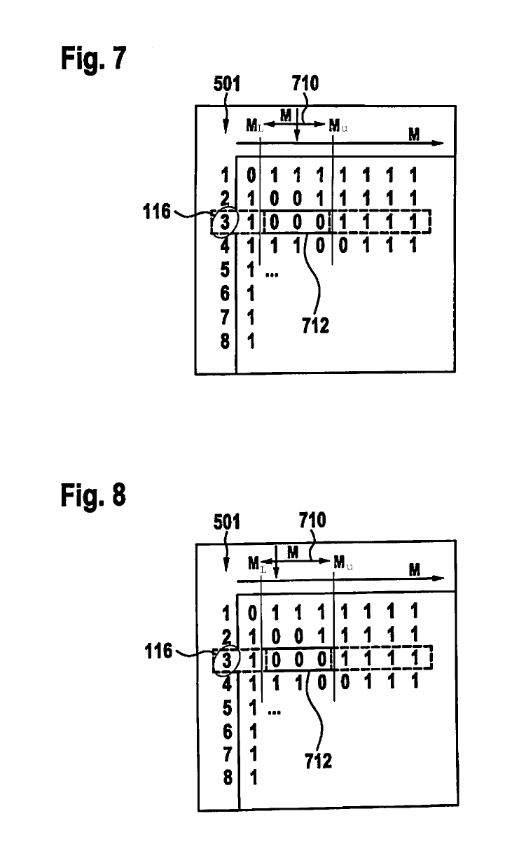

Consequently, control variant AI is activated precisely when measured value M has been measured and the error of measured value M is such that, for M: M_{L}<M<Mᵤ in each case. This means that both the measured value and the measurement error must be transmitted. The control variant assigned to value M, as is shown in FIGS. 7 and 8, is then activated in accordance with mapping a: M->Aₗ.

FIG. 7 shows a risk matrix G according to an exemplary embodiment, in which an error range 710 of M is plotted. The correct control variants 501 are each plotted on the ordinate. Measured value M has been measured. In this exemplary embodiment, it corresponds to control variant “3.” If error 710 is such that M definitely lies between M_{L} and Mᵤ, then control variant “3” is activated as the selected control variant 116. In this context, through error 710, which may be regarded as an inaccuracy value for situational value M, a set 712 of control variants is determined, from which the selected control variant 116 is selected, if the control variants included in set 712 of control variants satisfy the necessary safety criterion, which, according to this exemplary embodiment, is indicated by the entry “0.”

FIG. 8 shows a risk matrix G according to an exemplary embodiment, in which an error range 710 of M is plotted. The correct control variants 501 are each plotted on the ordinate.

Measured value M has been measured. In this exemplary embodiment, it corresponds to control variant “2.” The control variant that is actually correct would be “3.” Nevertheless, variant “3” is activated, since value M lies between M_{L} and Mᵤ and no additional risk to the occupant occurs due to control variant “2.”

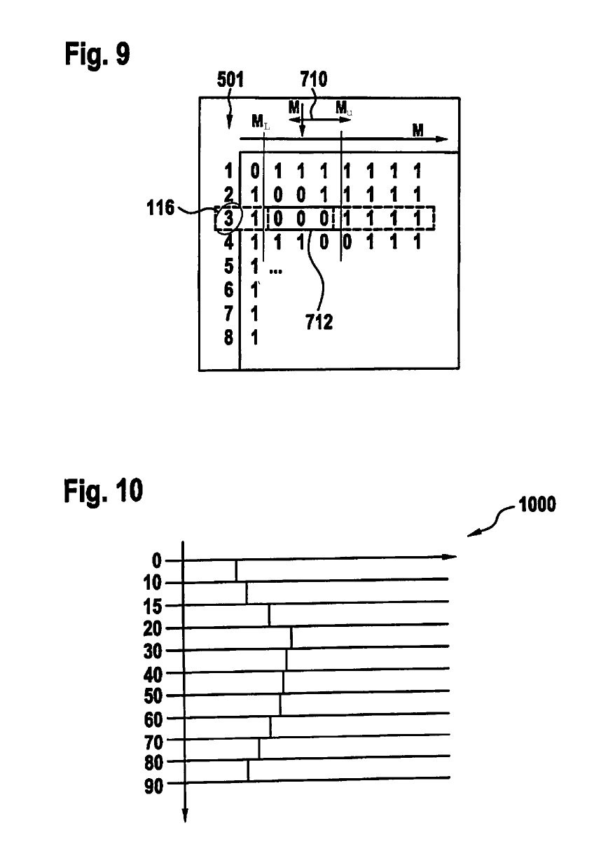

If this condition is not satisfied, then a control instance must be selected, by which it is ensured that no additional risk to the occupant is associated with it. This is usually a control instance, which constitutes suitable, but no longer optimum protection of the occupant, as is shown in FIG. 9.

FIG. 9 shows a risk matrix G according to an exemplary embodiment, in which an error range 710 of M is plotted. The correct control variants 501 are each plotted on the ordinate. Measured value M corresponds to control instance “3.” However, the condition for this control instance is not satisfied: The error of measured value M exceeds the degree allowed for control instance “3.” A substitute control instance must be used.

Alternatively, the entries in the risk matrix may be made using any numbers, which describe the potential risk in a continuous manner in the case of an incorrect assignment. Then, in an analogous method, the conditions may be calculated from the entries of the risk matrix as a function of other variables or predetermined quantities.

The risk matrix is preferably stored as a table in the control unit, and the respective limits of the allowed range are each fetched out of the table in real time as a function of measured value M.

A different coding of the risk matrix, for example, a nested IF-structure, may save computing time and memory and is, of course, possible as well. In this case, an advantageous procedure is for a human expert to fill out matrix G, and for the trivial, but complex transformation into the IF-structure to take place automatically. In so doing, human errors, such as gaps in the range of definition of the function, are excluded. The matrix itself may easily be checked by a person. The method supports “Design for Validation” and, in the case of integrated functions, gains more and more in importance, since the complexity rises sharply with an increase in control units.

According to one exemplary embodiment, the risk matrix is laid out in such a manner, that the entries in this table may be changed as a function of other variables, in accordance with predefined computational rules. Thus, e.g., the position or speed of the occupant relative to the restraining devices or to the passenger compartment has influence on the performance and efficacy of the restraining devices. If these quantities are known, this may be taken into account through corresponding changes in the entries of the risk table.

If the case occurs in which the particular error interval is greater than the allowed error interval, then, by initiating one or more other determination methods, the particular error interval may be reduced to the point where it lies within the allowed one.

Instead of being a function of just one variable V, the control variants may also be a function of a combination of two or more variables V₁, V₂, . . . Vⱼ. Mapping a then appears as follows: a: V₁, V₂, . . . , Vⱼ->Aₘ. The same applies to value M. Risk matrix G then has to be adjusted appropriately, and the above-described method is to be applied to it in an analogous form.

One advantage of the present invention is that by suitably adjusting a confidence interval, this is not unnecessarily reduced in cases where this does not result in any increase of the risk to the occupant. This increases the availability and the usefulness of a system, which this method uses. A conventional method, which instead requires a rigid confidence interval independent of requirements, must define this according to the most strict requirement made. A result of this is that a restraint system, which uses this conventional method, switches over to the replacement requirement considerably more often and therefore has a lower performance.

In general, a system is fundamentally more efficient, if it is more tolerant to errors precisely in the cases where this error does not make a difference, and if conversely, in cases where an error has negative consequences, it weights it more heavily.

The method may be used for controlling the restraint system on the basis of measurements or the knowledge of all conceivable variables, such as occupant characteristics (mass, size, age, load-bearing capacity, etc.), pre-crash information (offset, crash speed, object characteristics, . . . ), own speed, acceleration signals, and the like.

Risk matrix G may be designed specifically for a particular actuator and, after being generated one time for it, may be used without adjustment with many different sensor topologies, which may be of variable quality.

An exemplary embodiment is described below in detail. In this context, by way of example, an application to an adaptive restraint system is described, which takes into account the age of the occupant in controlling the restraint system.

It is advantageous to consider the individual characteristics of the occupant in the control of a restraint system. In this context, occupant characteristics, such as mass, size and load-bearing capacity are of particular importance. In this context, the load-bearing capacity is typically a function of age and gender: With increasing age, bone density decreases gender-specifically with increasing age. The load-bearing capacity of the skeleton decreases in a corresponding manner. That is, the maximum permissible force, which a restraint system may apply without causing injuries to the occupant, is consequently an indirect function of the age of a person.

One option of making data, as that described above, accessible to the restraint system, is for the data of the user to be stored on a mobile communications device (mK). In addition, even a picture portrait of the occupant is stored on the communications device.

If the occupant takes a seat in an arbitrary vehicle, which is equipped with a corresponding device, communication between the vehicle and a mobile communications device is established. The mobile communications device initially transmits the image or image characteristics to the vehicle. Now, another image of the occupant is generated by a video system situated in the vehicle.

In a first step, by comparing the two images or image characteristics, it is now checked if the occupant situated in the vehicle matches the person, whose data set is found on the mobile communications device. If this is the case, the data set, in it, information about the gender and the age of the occupant, is transmitted to the vehicle. Independently of that, the vehicle system carries out an age and gender determination via the video system, using suitable methods. In this context, if an agreement is determined, the occupant protection system is set in accordance with the transmitted personal characteristics of the occupant. Apart from the characteristics indicated above, any others, such as body mass index or skin color or others, may also be transmitted. In addition to, or instead of age and gender, e.g., the mass or the size may also be determined, using suitable sensor technology in the vehicle.

The exemplary embodiment now relates to the use of the described method in accordance with the present invention, for the application of age determination; the incorrect value M being the value transmitted by the mobile communications device. Possible error F(M) is initially unknown. In the exemplary embodiment, it is limited in that, as described above, an estimation of the age of the person is made by a video system situated in the vehicle, on the basis of suitable, standard algorithms; an age interval, within which the age of the corresponding person definitely lies, being generated as the output of this algorithm. Consequently, information items M and F(M) are available.

The risk matrices are generated independently of them. In this context, for example, variable V, the real age of the occupant, is subdivided into 5-year and/or 10-year intervals, and a control variant of the restraint system is correspondingly established for each interval, as is shown in FIG. 10.

FIG. 10 shows a schematic representation 1000 of the control variants for the belt force (as an example) as a function of the variable, “age,” in accordance with an exemplary embodiment. In this context, the control variant, in this case, e.g., the belt force, is plotted on the abscissa, and the age in years is plotted on the ordinate.

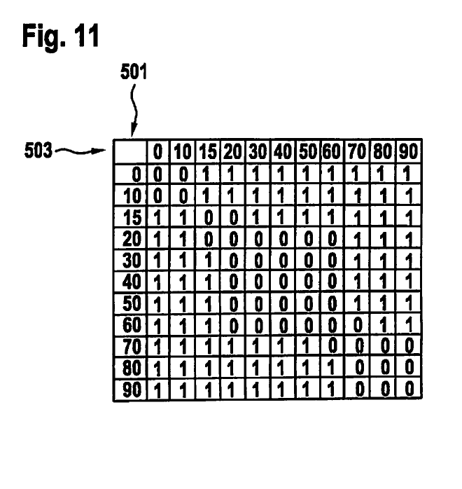

In the example of application, it is to be assumed that incorrect control in the age range between 20 years and 60 years does not mean an increased risk to the occupants, since in this case, the load-bearing capacity of the occupant only varies to a small extent. This analogously applies to other ranges. With that, the risk matrix may be set up as shown in FIG. 11.

FIG. 11 shows a corresponding risk matrix according to an exemplary embodiment. Assumed control variants 503 are entered in the uppermost row. Correct, age-dependent control variants 501 are entered in the first column.

The age information in the matrix always refers to the starting value of the age interval. For example, the line for the age 10 applies to the interval of 10-15 years.

From this information, the allowed error limits in the case of a given, measured value may now be calculated directly according to the described method.

This is explained in view of a first computational example. According to this computational example, the actual age of the occupant is 37 years. The mobile communications device transmits a value of 45 years for the age. An error interval of 35 years to 50 years for the age value is calculated from the data of the video system. The allowed error interval for the value of 45 years extends from 20 years to 60 years (calculated from the matrix). Consequently, the restraint system may be controlled, using the control variant that corresponds to the age interval of 40 years to 50 years.

According to a further computational example, the actual age of the occupant is 72 years. The mobile communications device transmits a value of 59 years for the age. An error interval of 50 years to 75 years for the age value is calculated from the data of the video system. The allowed error interval for the value of 59 years extends from 20 years to 60 years. Therefore, the determined error lies outside of the allowed error range, and the system must be controlled, using a replacement strategy. One advantage of the above-described method is that in this context, the allowed transition regions between different control variants, normally called “gray region” in conventional methods, are implicitly defined as well. Gray regions are always present, when “0” values are entered outside of the main diagonal. In these cases, the transition between the control variants is “sliding.” However, there may also be control variants, between which there are no gray regions, as is the case in the example between the age of 14 and 15 years.

If, in a first step of the described method, the defined interval is too large, then, in a following step, the error interval may be shortened by using additional measures. In the example of application, that could be implemented, e.g., using an age determination on the basis of a voice analysis of the occupant. In general, the overall error of a measurement is reduced by adding independent measurements.

Preferably, the risk matrix is adjusted to the gender of the occupant, using a computational method.

If an exemplary embodiment includes an “and/or” conjunction between a first feature and a second feature, then this is to be understood to mean that according to one specific embodiment, the exemplary embodiment includes both the first feature and the second feature, and according to a further specific embodiment, the exemplary embodiment includes either only the first feature or only the second feature.

1-10. (canceled)

11. A method for controlling a personal protection device for a vehicle, the method comprising:
determining a set of control variants for controlling the personal protection device, from a plurality of possible control variants for controlling the personal protection device, using an inaccurate situational value and at least one inaccuracy value, the inaccurate situational value representing a value ascertained using a sensor of the vehicle, and the inaccuracy value defining an inaccuracy of the inaccurate situational value; and
selecting a control variant assigned to the inaccurate situational value, from the plurality of possible control variants, as a control variant selected for controlling the personal protection device, if each control variant of the set of control variants is assigned a safety class, which satisfies a safety criterion necessary for controlling the personal protection device.

12. The method as recited in claim 11, wherein in the determining step, an interval of possible situational values justified by the inaccuracy is determined, using the inaccurate situational value and the at least one inaccuracy value, and control variants assigned to the possible situational values are determined from the plurality of possible control variants as the set of control variants.

13. The method as recited in claim 11, further comprising:
selecting a control variant classified as safe from the plurality of possible control variants, as the control variant selected for controlling the personal protection device, if at least one control variant of the set of control variants is assigned a safety class, which does not satisfy the safety criterion necessary for controlling the personal protection device.

14. The method as recited in claim 11, further comprising:
determining at least one adjusted inaccuracy value, using the at least one inaccuracy value and an adaptation rule, if at least one control variant of the set of control variants is assigned a safety class, which does not satisfy the safety criterion necessary for controlling the personal protection device;
determining an adjusted set of control variants, using the inaccurate situational value and the at least one adjusted inaccuracy value; and
selecting the control variant assigned to the inaccurate situational value as the control variant selected for controlling the personal protection device, if each control variant of the adjusted set of control variants is assigned a safety class, which satisfies the safety criterion necessary for controlling the personal protection device.

15. The method as recited in claim 11, further comprising:
checking if each control variant of the set of control variants is assigned a safety class, which satisfies the safety criterion necessary for controlling the personal protection device, the checking step being implemented using a lookup table.

16. The method as recited in claim 11, further comprising:
adjusting a safety class of at least one control variant, using a person-specific situational value which represents a value ascertained using a sensor of the vehicle.

17. The method as recited in claim 11, wherein in the step of determining the set of control variants, the set of control variants is determined, using at least one further, inaccurate situational value and at least one further inaccuracy value, the at least one further, inaccurate situational value representing a value ascertained, using a sensor of the vehicle, and the at least one further inaccuracy value defining an inaccuracy of the at least one further, inaccurate situational value, and wherein in the selecting step, a control variant assigned to the inaccurate situational value and to the at least one further, inaccurate situational value is selected from the plurality of possible control variants as the control variant selected for controlling the personal protection device, if each control variant of the set of control variants is assigned a safety class, which satisfies a safety criterion necessary for controlling the personal protection device.

18. A device for controlling a personal protection device for a vehicle, the device configured to
determine a set of control variants for controlling the personal protection device, from a plurality of possible control variants for controlling the personal protection device, using an inaccurate situational value and at least one inaccuracy value, the inaccurate situational value representing a value ascertained using a sensor of the vehicle, and the inaccuracy value defining an inaccuracy of the inaccurate situational value; and
select a control variant assigned to the inaccurate situational value, from the plurality of possible control variants, as a control variant selected for controlling the personal protection device, if each control variant of the set of control variants is assigned a safety class, which satisfies a safety criterion necessary for controlling the personal protection device.

19. A non-transitory machine-readable storage medium on which is stored a computer program for controlling a personal protection device for a vehicle, the computer program, when executed by a processing unit, causing the processing unit to perform:
determining a set of control variants for controlling the personal protection device, from a plurality of possible control variants for controlling the personal protection device, using an inaccurate situational value and at least one inaccuracy value, the inaccurate situational value representing a value ascertained using a sensor of the vehicle, and the inaccuracy value defining an inaccuracy of the inaccurate situational value; and
selecting a control variant assigned to the inaccurate situational value, from the plurality of possible control variants, as a control variant selected for controlling the personal protection device, if each control variant of the set of control variants is assigned a safety class, which satisfies a safety criterion necessary for controlling the personal protection device.
